(19) United States
(12) Patent Application Publication
(10) Pub. No.: US 2014/0336552 A1
(43) Pub. Date: Nov. 13, 2014

(54) MASSAGING APPARATUS AND METHOD

(71) Applicant: Edward George Varga, Jr., Union, NJ (US)

(72) Inventor: Edward George Varga, Jr., Union, NJ (US)

(21) Appl. No.: 14/272,011

(22) Filed: May 7, 2014

Related U.S. Application Data
(60) Provisional application No. 61/820,925, filed on May 8, 2013.

(51) Int. Cl. A61H 9/00; A61H 1/00

(52) U.S. Cl. CPC A61H 9/0007; A61H 1/008
USPC 601/149

(57) ABSTRACT

Methods and apparatus are disclosed for creating a massaging and heating/cooling operation with a closed-loop circulation system for working fluid, and in particular, a closed-loop circulation system that includes a controlled leak adjacent a pump for the working fluid to inject and release the working fluid.

### CROSS-REFERENCES TO RELATED APPLICATIONS

This application claims the benefit of U.S. Provisional Patent Application Ser. No. 61/820,925, filed 8 May, 2013, the contents of which are hereby incorporated by reference herein.

### BACKGROUND OF THE INVENTION

1. Field of the Invention

Methods and apparatus are disclosed for creating a massaging and heating/cooling operation with a closed-loop circulation system for working fluid, and in particular, a closed-loop circulation system that includes a controlled leak adjacent a pump for the working fluid to inject and release the working fluid.

2. Description of Related Art

The combination of heat (or both heating and cooling) plus massage forms the basis of therapies for a variety of conditions ranging from muscle aches and stiffness to deep vein thrombosis and is also used in some devices for the collection of clinical samples. Numerous means are known in the art to perform the heating and massage functions either independently of one another, such as when a heating device is used in conjunction with mechanical massage device, or in an integrated manner such as when a pulsating heated fluid simultaneously performs both functions. The present invention falls within this latter category.

Devices of this type almost invariably incorporate a distensible bladder that serves as the means of applying the heating/cooling and the mechanical massaging action to the target area. The size and shape of such a bladder depends upon the characteristics of the target site and can vary from approximately flat (for shoulders, backs and other large, flat areas) through conical (for breasts), to cylindrical (for arms and legs. Each bladder typically consists of a compliant front sheet that faces the target and can be inflated such that it contacts and conforms to the surface of the target, and a less compliant, but usually still somewhat flexible back sheet or support that restricts the ability of the bladder to expand away from the target. Bladders that are intended to provide mechanical action only (no heating) are often provided with a single port through which the working fluid enters and leaves the bladder while bladders that provide both thermal and mechanical action have two ports so that the working fluid can flow through the bladder. This flow-through arrangement facilitates delivery of heating and cooling to the target site, but complicates delivery of massaging mechanical action.

Other components of such devices include a console that houses the heaters, coolers, pumps, valves, and other components needed to provide the intended actions; a means to control these actions; and tubes, ducts or hoses that connect the console to the bladder

The preferred configuration of such a device is in the form of a closed loop that allows the working fluid to be recirculated. One common arrangement is shown in FIG. 1. In the arrangement illustrated a reservoir (104) containing the working fluid is connected to the inlet port (102) of a pump (101) which in turn moves the fluid through a heater (105) to the bladder before it returns to the reservoir. A cooling device may be included in the loop is appropriate to the intended use. The bladder is generally connected to the heater and reservoir via flexible tubes or hoses (106) to facilitate placement of the bladder on the patient being treated. The energy imparted to the working fluid by the pump results in the pressure at the pump inlet 102) being lower than the pressure at the pump outlet (103). It is this pressure differential that drives the flow of the working fluid through the components

### SUMMARY OF THE INVENTION

Devices and methods that combine a temperature change (e.g. heating and/or cooling) plus the action of a massage form the basis of therapies for a variety of conditions ranging from muscle aches and stiffness to deep vein thrombosis. Such devices and methods are also used for the collection of clinical samples. Numerous means are known in the art to perform the heating, for example, and massage functions either independently of one another. For instance, a heating device may be used in conjunction with mechanical massage device. Alternatively, a heating operation and massage operation may be performed in an integrated manner, such as when a pulsating heated fluid simultaneously performs both functions. The present disclosure relates to the latter category, where a heating operation and massage operation are performed in an integrated manner

Devices that perform a heating operation and a massage operation in an integrated manner typically include a distensible bladder that serves as the means of applying the heating/cooling and the mechanical massaging action to the target area Other components of such devices include a console that can house a heating apparatus, a cooling apparatus, pump(s), valve(s), and/or other components needed to provide the intended massaging and heating/cooling actions. Tubes, ducts, and/or hoses may connect the console to the bladder. These devices also may include a means to control these actions, so as an operational controller.

The size and shape of such a bladder depends upon the characteristics of the target site and can vary from approximately flat (for shoulders, backs and other large, flat areas), to conical (for breasts), to cylindrical (for arms and legs). Each bladder typically consists of a compliant front sheet that faces the target and can be inflated such that it contacts and conforms to the surface of the target, and a less compliant, but usually still somewhat flexible back sheet or support that restricts the ability of the bladder to expand away from the target. Bladders that are intended to provide mechanical action only (no heating) are often provided with a single port through which the working fluid enters and leaves the bladder while bladders that provide both thermal and mechanical action have two ports so that the working fluid can flow through the bladder. This flow-through arrangement facilitates delivery of heating and cooling to the target site, but complicates delivery of massaging mechanical action

Each component in the loop has a flow resistance (impedance) associated with it. As the flow rate of the working fluid between the pump outlet and inlet is constant under steady state conditions, the portion of the pressure differential that is created by the pump that is dissipated (“dropped”) by flow of the fluid through a component is proportional to the flow resistance of that component. Furthermore, the flow rate is determined by the initial pressure difference divided by the sum of all of the flow resistances and the total drop across all of the components is equal to the initial pressure differential. These relationships are accurate for incompressible fluids such as liquids and for compressible fluids such as gasses in the steady state, but accurately modeling the dynamic behavior of a compressible gas may require the addition of second order correction terms

When the pump is initially started, the pressure differential between the pump inlet and outlet rapidly increases to some value that is determined by the pump speed, the viscosity of the working fluid and other factors. The flow of working fluid through the system increases in step with the increase in pump pressure differential and stabilizes at a value that is proportional to the total flow resistance when the pump reaches its operating speed. The net effect of this flow is to establish a pressure drop across each component that is proportional to the flow resistance of the component and the flow rate. This, in turn, means that since the pressure drop across the bladder has stabilized, the pressure within the bladder and therefore its degree of inflation, will also have stabilized. Thus although a basic system such as illustrated in FIG. 1 can deliver warming or cooling by circulating heated or cooled working fluid through the bladder, it will not deliver the desired pulsating or massaging action unless other means are provided to perturb this equilibrium.

Numerous means are available to perturb the flow equilibrium and thereby create the desired massaging action

One such means is to modulate the speed of the pump which in turn modulates the pressure differential across the pump and ultimately the pressure within the bladder. At a minimum this requires a suitable motor speed control and adds to the complexity of the system. One such commercially available system of this type is the Halo System from Halo Healthcare in which both the speed and direction of the pump must be modulated under computer control in order to create the desired time varying pressure profile in the bladder. The Halo system also uses an aqueous glycol liquid as the working fluid, so leaks are an issue, the high heat capacity of the working fluid necessitates the use of a high wattage heater, and the time to bring the working fluid to the desired working temperature is prolonged

Another such means is to add a damper (variable flow restrictor) to the loop. As such a damper is closed, the flow resistance of the damper increases thereby increasing the pressure drop across the damper, increasing the pressure in those portions of the system upstream of the damper and decreasing the pressure in those portions of the system downstream of the damper. Opening and closing the damper therefore causes the bladder to deflate and inflate. In addition to requiring a means to vary the orientation of the damper, the flow resistance added by the damper increases the power needed to drive the pump and, if the working fluid is a gas, closing the damper can reduce the flow rate through the pump sufficiently to cause the flow to enter a region of instability where the pressure drop across the pump can fluctuate unpredictably by 25% or more. This type of instability is undesirable in a system such as a medical device that must be accurately controlled. An additional limitation of this approach is that the system must be made sufficiently robust to withstand both the increase in pressure upstream of the damper and the forces exerted by the increasing fluid velocity through the damper section as the damper is closed

Yet another approach is to periodically inject a bolus of working fluid into the system. Assuming that the pump has sufficient reserve capacity, this increase in the volume of working fluid results in an increase in system pressure thereby increasing inflation of the bladder. One limitation of this type of system is that it is necessary to release an equivalent volume of working fluid from the system when it is desired to deflate the bladder. FIG. 2 schematically illustrates the design of a system of this type that uses air as the working fluid. The point of injection is shown in this Figure as being at the inlet to the pump, but other injection locations may be used if desired. The complexity of this approach is readily apparent in this Figure. It should also be noted that in order to get adequate expansion of the bladder, the bolus of air needs to be injected at a significantly higher pressure than the steady state system working pressure.

It was unexpectedly discovered that when the working fluid is air, the functionality of the complex systems described above can be obtained by providing a simple controlled leak in proximity to the inlet port of the pump as is illustrated in FIG. 3. A suitable controlled leak can be implemented by incorporating a simple two-port open-closed valve having one port open to the atmosphere near the pump inlet or even more simply by using a passive pressure actuated duckbill or umbrella valve. A system incorporating a controlled leak delivers the desired functionality while addressing all of the limitations outlined above. This method additionally reduces the amount of heater power needed to heat the target tissue to the desired temperature

Without wishing to be bound by theory, this novel method utilizes the inherent tendency of the pump to attempt to maintain a constant difference in pressure between its inlet and outlet ports to generate a pressure pulse that transiently inflates the bladder as it propagates around the system loop. When the controlled leak is closed, the system functions as described above to establish a baseline pressure in the bladder. Under these conditions, the lowest pressure in the system is at the pump inlet and the pressure at the pump outlet is higher by an amount determined by the characteristics of the pump and the working fluid. Opening the controlled leak causes the pressure at the pump inlet to rise thereby causing the pump outlet pressure to rise by a corresponding amount. The resulting pressure pulse propagates through the system to the bladder where it causes the bladder to transiently inflate. When the pressure pulse reaches the controlled leak, the excess air ingested when the leak was opened is vented back to atmosphere thereby restoring the system to its original state. The pressure drop between 105 and 107 leaves a lower pressure on the bladder side, thereby deflating the bladder. This cycle is repeated each time that the controlled leak is opened and closed. It should be noted that the impedance of the tube or hose connecting the output of the bladder to the pump inlet plays important roles in this operating cycle by transiently restricting the flow of air out of the bladder thereby allowing pressure to build and the bladder to expand and also by restricting the backward propagation for the ingested bolus of air from the controlled leak to the bladder.

Comparison testing of controlled leak (FIG. 3) and pulse injection (FIG. 2) systems has revealed additional benefits of the controlled leak approach. By way of example, in tests comparing the two approaches in systems that were configured to deliver equal degrees of bladder expansion and to require equal amounts of time to bring the surface of the bladder to a specified temperature, the controlled leak approach exhibited a significantly lower equilibrium pressure (approximately 2 PSI vs. approximately 5 PSI), required a much lower pressure transient (about 1 PSI induced vs 20 PSI injected) to achieve the desired bladder inflation, and required a lower wattage heater (250 W vs 750 W). Among other benefits, these results indicate that a controlled leak system will exhibit better long term reliability and will be more economical to operate

Numerous embodiments and applications of the controlled leak approach are envisioned. These include, but are not limited to therapeutic devices delivering appropriate combinations of heating, cooling and massage to specific anatomical sites on a patient; devices that apply heat and massage to enhance the collection of samples such as sweat and nipple aspirate fluid for clinical laboratory testing, and consoles that can actuate multiple bladders simultaneously.

We claim a means of simultaneously delivering heat and/or cooling in combination with a massaging action to an anatomical site by means of the flow of air or another gaseous working fluid around a closed loop path wherein the pressure within the closed loop can be modulated by opening and closing a controlled leak

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is a diagrammatic view of one embodiment of a standard massage apparatus;

FIG. 2 is a diagrammatic view of another embodiment of a standard massage apparatus, and

FIG. 3 is a diagrammatic view of a massage apparatus of the present invention

### DETAILED DESCRIPTION

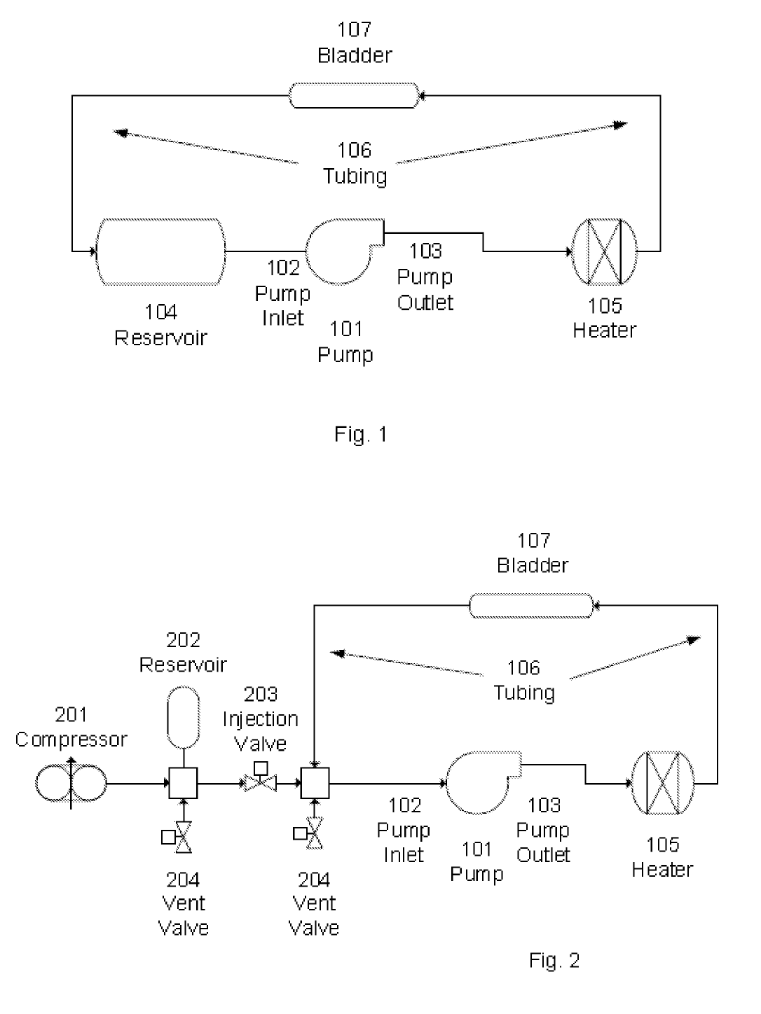

A typical configuration of a device that performs heating and massaging operations in an integrated manner is illustrated in FIG. 1. Such a device is in the form of a closed loop system that allows a working fluid in the device to be circulated and recirculated throughout the system. In the arrangement, as illustrated in FIG. 1, a reservoir 104 containing the working fluid is connected to an inlet port 102 of a pump 101. The pump 101 includes an outlet port 103 and pumps the working fluid through the system. After the working fluid exits the outlet port 103, the working fluid is moved through a heater 105 to a bladder 107 before it returns to the reservoir 104. A cooling device may be included in the loop as appropriate to the intended use. The bladder 107 is generally connected to the heater 105 and reservoir 104 via flexible tubes or hoses 106 to facilitate placement of the bladder 107 on the patient being treated. The energy imparted to the working fluid by the pump 101 results in the pressure at the pump inlet port 102 (after it has been circulated through the reservoir 104) being lower than the pressure at the pump outlet port 103. It is this pressure differential that drives the flow of the working fluid through the components of the system.

Each component in the loop has a flow resistance (impedance) associated with it. Because the flow rate of the working fluid between the pump outlet port 103 and the pump inlet port 102 is constant under steady state conditions, the portion of the pressure differential that is created by the pump 101 that is dissipated (“dropped”) by flow of the fluid through a component is proportional to the flow resistance of that component. Furthermore, the flow rate is determined by the initial pressure difference divided by the sum of all of the flow resistances and the total drop across all of the components is equal to the initial pressure differential. These relationships are accurate for incompressible fluids such as liquids and for compressible fluids such as gasses in the steady state, but accurately modeling the dynamic behavior of a compressible gas may require the addition of second order correction terms

When the pump is initially started, the pressure differential between the pump inlet port 102 and pump outlet port 103 rapidly increases to some value that is determined by the speed of the pump 101, the viscosity of the working fluid, and other factors. The flow of working fluid through the system increases in step with the increase in pump pressure differential and stabilizes at a value that is proportional to the total flow resistance when the pump reaches its operating speed. The net effect of this flow is to establish a pressure drop across each component that is proportional to the flow resistance of the component and the flow rate. This, in turn, means that since the pressure drop across the bladder 107 stabilizes, the pressure within the bladder 107, and therefore its degree of inflation and deflation, will also have stabilized. Thus, although a basic system such as illustrated in FIG. 1 can deliver warming or cooling by circulating heated or cooled working fluid through the bladder 107, it will not deliver the desired pulsating or massaging action unless other means are provided to perturb this equilibrium.

Several means for perturbing the flow equilibrium, and thereby creating the desired massaging action, are available. One such approach is to periodically inject a bolus of working fluid into the system, as illustrated in FIG. 2. For example, FIG. 2 shows a system that utilizes air as the working fluid, injecting the air into the system through an injection valve 203 placed before the pump 101. The point of injection is shown in FIG. 2 as being before the inlet port 102 of the pump 101, but other injection locations may be used if desired. The injection valve 203 is used to inject fluid into the system from a reservoir 202, the working fluid being forced from the reservoir 202 to the injection valve 203 by any known means, such as the use of a compressor 201. Valve vents 204 are located near the injection sit and the compression site of the working fluid to release additional fluid when desiring to reduce the amount of fluid in, and therefore deflate, the bladder 107. Assuming that the pump 102 has sufficient reserve capacity, the increase in the volume of working fluid from injection of a bolus results in an increase in system pressure, thereby increasing inflation of the bladder 107. One limitation of this type of system is that it is necessary to release an equivalent volume of working fluid from the system when it is desired to deflate the bladder 107. The complexity of this approach is readily apparent in FIG. 2. Further, in order to get adequate expansion of the bladder 107, the bolus of air needs to be injected at a significantly higher pressure than the steady state system working pressure.

Another such means is to modulate the speed of the pump 101, which, in turn, modulates the pressure differential across the pump 101 and ultimately the pressure within the bladder 107. At a minimum, this requires a suitable motor speed control (not shown) and also adds to the complexity of the system. One such commercially available system of this type is the Halo System from Halo Healthcare in which both the speed and direction of the pump must be modulated under computer control in order to create the desired time varying pressure profile in the bladder. The Halo system also uses an aqueous glycol liquid as the working fluid, so leaks are an issue. Further, the high heat capacity of this type of working fluid necessitates the use of a high wattage heater, and the time to bring the working fluid to the desired working temperature is prolonged

Another such means is to add a damper or variable flow restrictor (not shown) to the loop. When such a damper is closed, the flow resistance of the damper increases, thereby increasing the pressure drop across the damper, increasing the pressure in those portions of the system upstream of the damper and decreasing the pressure in those portions of the system downstream of the damper. Opening and closing the damper therefore causes the bladder 107 to deflate and inflate. In addition to requiring a means to vary the orientation of the damper, the flow resistance added by the damper increases the power needed to drive the pump 101 and, if the working fluid is a gas, closing the damper can reduce the flow rate through the pump 101 sufficiently to cause the flow to enter a region of instability where the pressure drop across the pump 101 can fluctuate unpredictably by 25% or more. This type of instability is undesirable in a system such as a medical device that must be accurately controlled. An additional limitation of this approach is that the system must be made sufficiently robust to withstand both the increase in pressure upstream of the damper and the forces exerted by the increasing fluid velocity through the damper section as the damper is closed

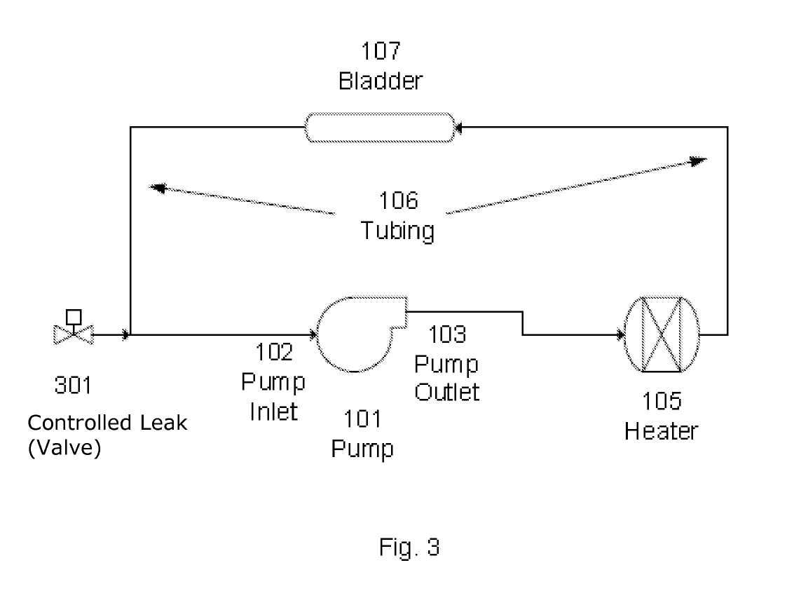

A device of the present disclosure, as illustrated in FIG. 3, provides the functionality of the complex systems described above when the working fluid is air. Such functionality is obtained by providing a simple controlled leak 301 in proximity to the inlet port 102 of the pump 101, as is illustrated in FIG. 3. In illustrative embodiments, a suitable controlled leak 301 can be implemented by incorporating a simple two-port, open-closed valve having one port open to the atmosphere near the pump inlet port 102, or even more simply by using a passive pressure actuated duckbill or umbrella valve. Other means of a providing a controlled leak 301 are also envisioned. A system incorporating a controlled leak 301 delivers the desired functionality while avoiding the additional issues discussed with respect to the other devices. This method additionally reduces the amount of heater power needed to heat the target tissue to the desired temperature.

Without wishing to be bound by theory, this novel method utilizes the inherent tendency of the pump 101 to attempt to maintain a constant difference in pressure between its inlet port 102 and outlet port 103 to generate a pressure pulse that transiently inflates the bladder 107 as it propagates around the system loop. When the controlled leak 301 is closed, the system functions as described above with respect to FIG. 1 to establish a baseline pressure in the bladder 107. Under these conditions, the lowest pressure in the system is at the pump inlet port 101 and the pressure at the pump outlet port 103 is higher by an amount determined by the characteristics of the pump 101 and the working fluid. Opening the controlled leak 301 causes the pressure at the pump inlet port 102 to rise, thereby causing the pressure at the pump outlet port 103 to rise by a corresponding amount. The resulting pressure pulse propagates through the system to the bladder 107 where it causes the bladder 107 to transiently inflate. When the pressure pulse reaches the controlled leak 301, the excess air ingested when the leak was opened is vented back to atmosphere, thereby restoring the system to its original state. This cycle is repeated each time that the controlled leak 301 is opened and closed. It should be noted that the impedance of the tube or hose 106 connecting an output of the bladder 107 to the pump inlet 102 plays an important role in this operating cycle by transiently restricting the flow of air out of the bladder 107. This allows pressure to build and the bladder 107 to expand, and also restricts the backward propagation for the ingested bolus of air from the controlled leak 301 to the bladder 107.

Based on comparative testing, the controlled leak 301 approach as illustrated in FIG. 3 has additional benefits over the other methods illustrated in FIGS. 1 and 2. By way of example, in tests comparing the approaches in systems that were configured to deliver equal degrees of bladder 107 expansion and to require equal amounts of time to bring the surface of the bladder 107 to a specified temperature, the controlled leak 301 approach of FIG. 3 exhibited a significantly lower equilibrium pressure (approximately 2 PSI vs approximately 6 PSI in FIG. 2); required a much lower pressure transient (about 1 PSI induced vs 20 PSI injected in FIG. 2) to achieve the desired bladder 107 inflation; and required a lower wattage heater (250 W vs 750 W in FIG. 2). Among other benefits, these results indicate that a controlled leak 301 system as illustrated in FIG. 3 will exhibit better long-term reliability and will be more economical to operate

Numerous embodiments and applications of the controlled leak 301 approach as illustrated in FIG. 3 are envisioned. These include, but are not limited to therapeutic devices delivering appropriate combinations of heating, cooling and massage to specific anatomical sites on a patient; devices that apply heat and massage to enhance the collection of samples such as sweat and nipple aspirate fluid for clinical laboratory testing; and consoles that can actuate multiple bladders 107 simultaneously

Obviously, many modifications and variations of the present invention are possible in light of the above teachings. It is therefore to be understood that within the scope of the appended claims, the invention may be practiced otherwise than as specifically described.

1. A massaging apparatus comprising a closed-loop system that circulates a working fluid, the closed-loop system comprising: a pump that circulates the working fluid through the closed-loop system, the pump including an inlet port and an outlet port; a bladder in fluid communication with the pump, the bladder including an interior cavity configured to receive the working fluid, the bladder configured to be placed on an anatomical site to be expanded or contracted with different amounts of working fluid; and a controlled leak adjacent the inlet port of the pump, the controlled leak modulating the pressure within the closed-loop system such that the bladder expands or contracts based on operation of the controlled leak.

2. The massaging apparatus of claim 1, wherein the closed-loop system further includes a heater to regulate the temperature of the working fluid flowing through the bladder.

3. The massaging apparatus of claim 1, wherein the closed-loop system further includes a cooler to regulate the temperature of the working fluid flowing through the bladder.

4. The massaging apparatus of claim 1, wherein the controlled leak is a two port, open-close valve.

5. The massaging apparatus of claim 1, wherein the controlled leak is an actuated duckbill valve.

6. The massaging apparatus of claim 1, wherein the controlled leak is an umbrella valve.

7. The massaging apparatus of claim 1, wherein the working fluid is air.

8. A method for massaging with a working fluid, the method comprising: circulating the working fluid through a closed-loop system, the closed-loop system including a pump with an inlet port and an outlet port, an inflatable and deflatable bladder in fluid communicate with the pump, and a controlled leak adjacent the inlet port of the pump, opening and closing the controlled leak in order to modulate the pressure inside the closed-loop system; and inflating and deflating the bladder through opening and closing the controlled leak.
